(19) United States
(12) Patent Application Publication
(10) Pub. No.: US 2017/0176663 A1
(43) Pub. Date: Jun. 22, 2017

(54) EDGE-LIT BACKLIGHT UNIT AND REFLECTIVE TAPE MEMBER

(71) Applicant: KEIWA INC., Osaka-shi, Osaka (JP)

(72) Inventors: Akira FURUTA, Osaka-shi, Osaka (JP); Hironori NAKASHIMA, Osaka-shi, Osaka (JP)

(21) Appl. No.: 15/316,065

(22) PCT Filed: Jun. 8, 2015
(86) PCT No.: PCT/JP2015/066520

§ 371 Date: Mar. 9, 2017

(30) Foreign Application Priority Data
Jun. 6, 2014 (JP) 2014-118084
Jun. 6, 2014 (JP) 2014-118085
Jun. 8, 2015 (JP) 2015-115477

(51) Int. Cl. F21V 8/00

(52) U.S. Cl. CPC G02B 6/0031; G02B 6/002

(57) ABSTRACT

The edge-lit backlight unit according to the present invention includes a light guide film having an average thickness of no less than 100 μm and no greater than 600 μm; at least one thin light source disposed so as to face at least one end face of the light guide film, in which rays of light emitted from the thin light source exit from a front face of the light guide film; and a first reflection tape disposed so as to cover a front face side of an end edge on a side of the at least one thin light source of the light guide film. The first reflection tape may be disposed so as to cover a front face side of a gap between the at least one thin light source and the light guide film.

### TECHNICAL FIELD

The present invention relates to an edge-lit backlight unit and a reflection tape member.

### BACKGROUND ART

Liquid crystal display devices in widespread use have been in a backlight system where light emission is executed by illuminating a liquid crystal layer from the rear face. In this system, a backlight unit such as an edge-lit backlight unit or a direct-lit backlight unit is mounted on the back side of the liquid crystal layer. As shown in FIG. 17, such an edge-lit backlight unit 110 generally includes a reflection sheet 115 disposed on the front face of the top plate 116, a light guide plate 111 disposed on the front face of the reflection sheet 115, an optical sheet 112 disposed on the front face of the light guide plate 111, and a light source 117 that emits rays of light toward the end face of the light guide plate 111 (see Japanese Unexamined Patent Application, Publication No. 2010-177130). In the edge-lit backlight unit 110 shown in FIG. 17, a plurality of light emitting diodes (LEDs) are used as the light source 117, for example, and the rays of light emitted from the light source 117 and enter the light guide plate 111 propagate through the light guide plate 111. A part of the propagating rays of light exits from the back face of the light guide plate 111, is reflected on the reflection sheet 115 and enters again the light guide plate 111.

In liquid crystal display devices having such a liquid crystal display unit, in order to enhance its portability and user-friendliness, a reduction in thickness and weight is required, leading to a requirement also for a reduction in thickness of the liquid crystal display unit. In particular, in an ultraslim mobile terminal in which the thickness of the thickest part of its housing is no greater than 21 mm, it is desired that the thickness of the liquid crystal display unit is about 4 mm to 5 mm, and thus, an even further reduction in thickness of the edge-lit backlight unit incorporated into the liquid crystal display unit has been desired.

### PRIOR ART DOCUMENTS

### Patent Documents

Patent Document 1: Japanese Unexamined Patent Application, Publication No. 2010-177130

### SUMMARY OF THE INVENTION

### Problems to be Solved by the Invention

In such an edge-lit backlight unit for the ultraslim mobile terminal, since the thickness of the liquid crystal display unit falls within the above range, a further reduction in thickness of the light guide plate is required as well. In view of this, it has been proposed that, as a light guide plate used for such an edge-lit backlight unit for the ultraslim mobile terminal, a thin film-like light guide film having a substantially uniform thickness is used in place of conventional relatively thick light guide plates having a substantially wedge shape in cross section.

The present inventors found that, when a liquid crystal display device provided with such a light guide film is used, luminance may decrease to a greater extent than that of conventional liquid crystal display devices. The present inventors thoroughly investigated regarding the defect, and consequently found that, due to a reduction in thickness of the light guide film being promoted, rays of light emitted from a light source are not allowed to sufficiently enter the light guide film through an end face of the light guide film.

The present invention was made in view of the foregoing circumstances, and an object of the present invention is to provide an edge-lit backlight unit that is capable of enhancing the utilization efficiency of rays of light and thus promoting the improvement of luminance, by allowing the rays of light emitted from a light source to enter a light guide film accurately. Moreover, another object of the present invention is to provide a reflection tape member that enables the rays of light emitted from the light source to enter the light guide film accurately.

### Means for Solving the Problems

According to an aspect of the present invention made for solving the aforementioned problems, an edge-lit backlight unit is provided which includes: a light guide film having an average thickness of no less than 100 μm and no greater than 600 μm; at least one thin light source disposed so as to face at least one end face of the light guide film, in which rays of light emitted from the thin light source exit from a front face of the light guide film; and a first reflection tape disposed so as to cover a front face side of an end edge on a side of the at least one thin light source of the light guide film.

Since rays of light emitted from a light source such as an LED are generally diffused rays of light, some of the rays of light emitted from the light source in an edge-lit backlight unit are lost, without entering an end face of a light guide film or without propagating appropriately in the light guide film. Furthermore, such a loss of rays of light is more significant as a reduction in thickness of the light guide film is promoted. In these regards, since the edge-lit backlight unit of the aspect of the present invention includes the first reflection tape that is disposed so as to cover the front face side of the end edge on the side of the at least one thin light source of the light guide film, rays of light emitted from the at least one thin light source are reflected by the first reflection tape, and the rays of light reflected by the first reflection tape are then enabled to enter the light guide film. Therefore, according to the edge-lit backlight unit, even when the average thickness of the light guide film is relatively small, falling within a range of no less than 100 μm and no greater than 600 μm, the utilization efficiency of rays of light can be enhanced and thus the improvement of luminance can be promoted, by allowing the rays of light emitted from the at least one thin light source to enter the light guide film accurately.

The first reflection tape is preferably disposed so as to cover a front face side of a gap between the at least one thin light source and the light guide film. When the first reflection tape is disposed so as to cover the front face side of the gap between the at least one thin light source and the light guide film, rays of light that are emitted from the at least one thin light source and diffused on the front face side with respect to an end face of the light guide film that faces the thin light source are reflected by the first reflection tape and then allowed to enter the light guide film.

It is preferred that the edge-lit backlight unit further includes a second reflection tape disposed so as to cover a back face side of the gap between the at least one thin light source and the light guide film. When the edge-lit backlight unit further includes the second reflection tape disposed so as to cover the back face side of the gap between the at least one thin light source and the light guide film, rays of light that are emitted from the at least one thin light source and diffused on the back face side with respect to an end face of the light guide film that faces the thin light source are reflected by the second reflection tape and then allowed to enter the light guide film.

The light guide film preferably includes a triangular prism portion which is formed so that a thickness of the light guide film at the end edge, at which the at least one thin light source is disposed, increases gradually along a front face toward an end side of the light guide film, and the first reflection tape may be disposed so as to cover a front face of the prism portion. When the light guide film includes the triangular prism portion which is formed so that the thickness of the light guide film at the end edge, at which the at least one thin light source is disposed, increases gradually along the front face toward the end side of the light guide film, the area of an end face of the light guide film where the rays of light enter can be increased by means of the prism portion and thus the rays of light emitted from the thin light source are easily allowed to enter the light guide film. Furthermore, since the first reflection tape is disposed so as to cover the front face of the prism portion, the rays of light that are allowed to enter the prism portion can be prevented from being transmitted through the prism portion and directly exiting outside the light guide film.

The first reflection tape preferably includes a reflection layer including a matrix containing a resin as a principal component, and a white pigment included in the matrix. When the first reflection tape includes the reflection layer including a matrix including a resin as a principal component, and a white pigment included in the matrix, a plurality of micro uneven shapes that result from the white pigment are easily formed on a back face of the reflection layer, and thus rays of light that are emitted from the thin light source and are allowed to enter the first reflection tape can be diffused adequately by means of the micro uneven shapes. Therefore, angles of incidence of the rays of light to the light guide film which are reflected by the first reflection tape can be adjusted adequately, and propagation ability in the light guide film of the rays of light that are allowed to enter the light guide film can be improved.

It is preferred that the first reflection tape further includes an adhesive layer laminated on the reflection layer, and the first reflection tape is bonded to the at least one thin light source and the light guide film by means of the adhesive layer. When the first reflection tape further includes an adhesive layer laminated on the reflection layer, and the first reflection tape is bonded to the at least one thin light source and the light guide film by means of the adhesive layer, leakage of rays of light from between the first reflection tape and the light guide film can be prevented and thus the rays of light emitted from the thin light source are enabled to enter the light guide film more accurately.

The first reflection tape is preferably bonded to the at least one thin light source and the light guide film in a temporarily adhered state. When the first reflection tape is bonded to the at least one thin light source and the light guide film in a temporarily adhered state, leakage of rays of light from between the first reflection tape and the light guide film can be prevented, and the disposition and replacement of the first reflection tape can be easily performed.

A reflection tape member according to another aspect of the present invention that is made for solving the aforementioned problems may be used as the first reflection tape of the edge-lit backlight unit of the aforementioned aspect of the invention.

By using the reflection tape member as the first reflection tape of the edge-lit backlight unit, rays of light emitted from the thin light source are enabled to enter the light guide film accurately.

It should be noted that the term “front face side” as referred to herein means a viewer's side when a backlight unit, etc. is incorporated into a liquid crystal display device, and the term “back face side” means a side opposite to the front face side. The term “principal component” as referred to means a component having the most content, and, for example, means a component having a content of no less than 50% by mass. The term “temporarily adhered state” as referred to means a state of being easily peeled away by simply pulling by a hand at normal temperature (25° C.), with the peeling strength of, for example, no less than 0.02 N/5 cm and no greater than 5 N/5 cm, and preferably no less than 0.1 N/5 cm and no greater than 1 N/5 cm.

### Effects of the Invention

As explained in the foregoing, the edge-lit backlight unit according to the aspect of the present invention is capable of enhancing the utilization efficiency of rays of light and thus promoting the improvement of luminance, by allowing the rays of light emitted from a light source to enter a light guide film accurately. Furthermore, the reflection tape member according to the another aspect of the present invention enables the rays of light emitted from the light source to enter the light guide film accurately.

### BRIEF DESCRIPTION OF THE DRAWINGS

FIG. 1 is a schematic perspective view of a mobile terminal according to an embodiment of the present invention illustrating: (a) an opening state of a liquid crystal display unit; and (b) a closing state of the liquid crystal display unit;

FIG. 2 is a schematic cross sectional view illustrating an edge-lit backlight unit of the mobile terminal of FIG. 1;

FIG. 3 is a schematic partially enlarged view illustrating a production apparatus of a light guide film of the backlight unit of FIG. 2;

FIG. 4 is a schematic cross sectional view illustrating a backlight unit according to an embodiment other than the backlight unit of FIG. 2;

FIG. 5 is a schematic cross sectional view illustrating a backlight unit according to an embodiment other than the backlight units of FIGS. 2 and 4;

FIG. 6 is a schematic cross sectional view illustrating a backlight unit according to an embodiment other than the backlight units of FIGS. 2, 4, and 5;

FIG. 7 is a schematic cross sectional view illustrating a light guide film according to another embodiment of the present invention;

FIG. 8 is a schematic cross sectional view illustrating a backlight unit according to an embodiment other than the backlight units of FIGS. 2, 4, 5, and 6;

FIG. 9 is a schematic cross sectional view illustrating a backlight unit according to an embodiment other than the backlight units of FIGS. 2, 4, 5, 6, and 8;

FIG. 10 is a schematic cross sectional view illustrating a backlight unit according to an embodiment other than the backlight units of FIGS. 2, 4, 5, 6, 8, and 9;

FIG. 11 is a schematic cross sectional view illustrating a backlight unit according to an embodiment other than the backlight units of FIGS. 2, 4, 5, 6, and 8 to 10;

FIG. 12 is a schematic cross sectional view illustrating a backlight unit according to an embodiment other than the backlight units of FIGS. 2, 4, 5, 6, and 8 to 11;

FIG. 13 is a schematic cross sectional view illustrating a backlight unit according to an embodiment other than the backlight units of FIGS. 2, 4, 5, 6, and 8 to 12;

FIG. 14 is a schematic cross sectional view illustrating a backlight unit according to an embodiment other than the backlight units of FIGS. 2, 4, 5, 6, and 8 to 13;

FIG. 15 is a schematic cross sectional view illustrating a backlight unit according to an embodiment other than the backlight units of FIGS. 2, 4, 5, 6, and 8 to 14;

FIG. 16 is a schematic cross sectional view illustrating a backlight unit according to an embodiment other than the backlight units of FIGS. 2, 4, 5, 6, and 8 to 15; and

FIG. 17 is a schematic cross sectional view illustrating a conventional edge-lit backlight unit.

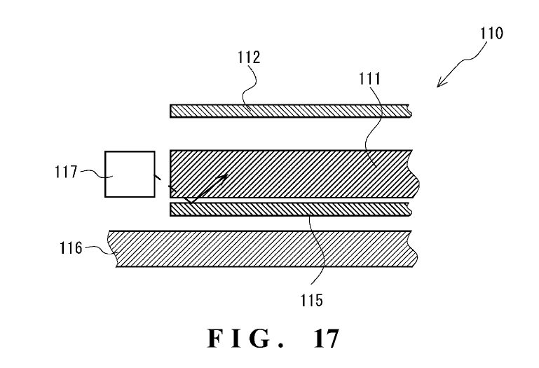

### DESCRIPTION OF EMBODIMENTS

Hereinafter, preferred modes for carrying out the invention will be explained in more detail with references to the drawings, if necessary.

### First Embodiment

Mobile Terminal

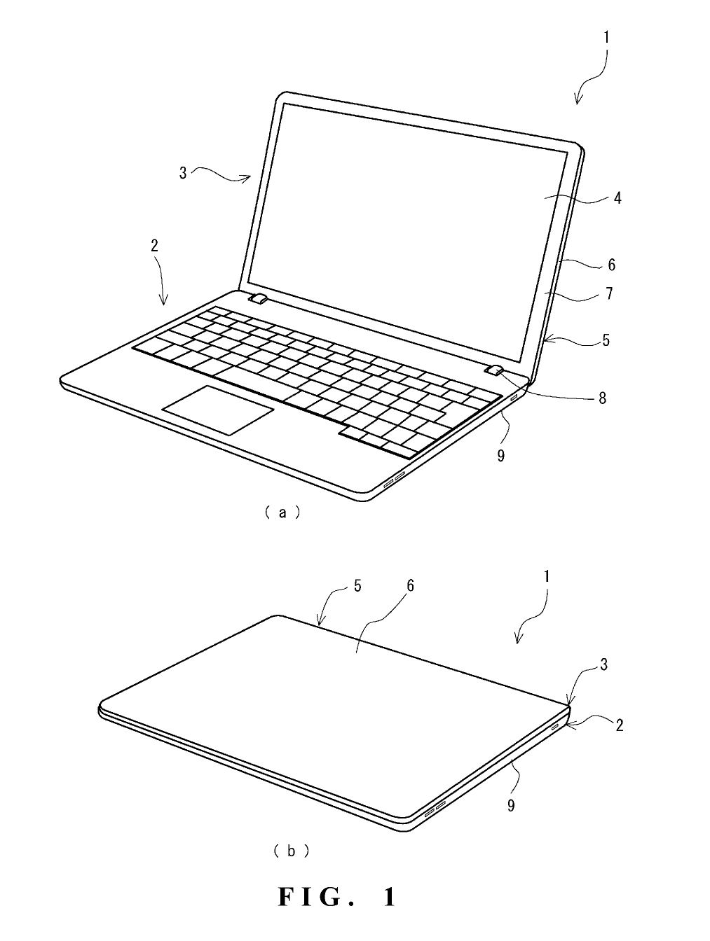

A mobile terminal 1 of FIG. 1 includes an operation unit 2 and a liquid crystal display unit 3 rotatably (enabling to be opened/closed) attached to the operation unit 2. A housing (a casing) that totally accommodates components of the mobile terminal 1 has a thickness (at the thickest part (when the liquid crystal display unit 3 is closed)) of no greater than 21 mm, and the mobile terminal 1 is an ultraslim laptop computer (hereinafter, it may also be referred to as “ultraslim computer 1”).

The liquid crystal display unit 3 of the ultraslim computer 1 includes a liquid crystal panel 4 and an ultrathin edge-lit backlight unit that emits rays of light toward the liquid crystal panel 4 from a back face side thereof (hereinafter, it may also be referred to as “backlight unit”). The liquid crystal panel 4 is held at the back face, the lateral face, and a circumference of the front face by a casing for a liquid crystal display unit 5 of the housing. In this embodiment, the casing for a liquid crystal display unit 5 includes a top plate 6 disposed on the back face (and the rear face) of the liquid crystal panel 4, and a front face support member 7 disposed on the front face side of the circumference of the front face of the liquid crystal panel 4. The housing of the ultraslim computer 1 includes the casing for a liquid crystal display unit 5 and a casing for an operation unit 9 that is rotatably attached to the casing for a liquid crystal display unit 5 through a hinge part 8 and contains a central processing unit (ultra-low voltage CPU) and the like.

Although the average thickness of the liquid crystal display unit 3 is not particularly limited as long as the thickness of the housing falls within a desired range, the upper limit of the thickness of the liquid crystal display unit 3 is preferably 7 mm, more preferably 6 mm, and still more preferably 5 mm. On the other hand, the lower limit of the thickness of the liquid crystal display unit 3 is preferably 2 mm, more preferably 3 mm, and still more preferably 4 mm. When the average thickness of the liquid crystal display unit 3 is greater than the above upper limit, it may be difficult to satisfy a requirement of a reduction in thickness of the ultraslim computer 1. Furthermore, when the average thickness of the liquid crystal display unit 3 is less than the above lower limit, a decrease in strength and/or in luminance and the like of the liquid crystal display unit 3 may be incurred.

### Backlight Unit

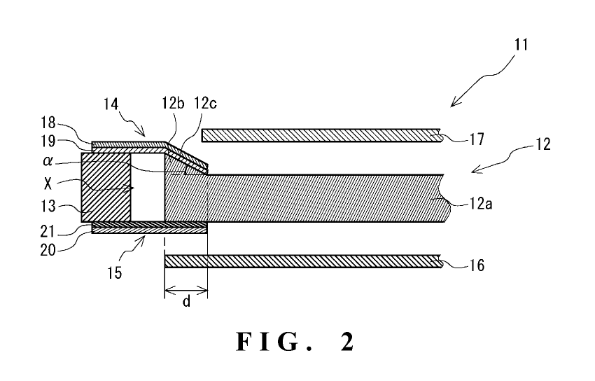

The backlight unit 11 of FIG. 2 is provided to the liquid crystal display unit 3 of the ultraslim computer 1. The backlight unit 11 includes a light guide film 12, at least one thin light source 13 that allow rays of light to enter an end face of the light guide film 12, a first reflection tape 14 disposed so as to cover a front face side of an end edge on the side of the at least one thin light source 13 of the light guide film 12, a second reflection tape 15 disposed so as to cover a back face side of an end edge on the side of the at least one thin light source 13 of the light guide film 12, a reflection sheet 16 disposed on the back face side of the light guide film 12, and an optical sheet 17 disposed on the front face side of the light guide film 12. The backlight unit 11 allows rays of light emitted from the at least one thin light source 13 to exit from the front face of the light guide film 12 in a substantially uniform manner.

Light Guide Film

The light guide film 12 includes a main body 12a formed in a plate-like shape having the total average thickness falling within a range of no less than 100 μm and no greater than 600 μm, which is formed so that the entire light guide film 12 has an average thickness falling within a range of no less than 100 μm and no greater than 600 μm. Furthermore, the light guide film 12 is formed in a substantially rectangular shape in a planar view. The entire light guide film 12 is formed in a thin-plate like shape (non-wedge shape) having a substantially uniform thickness entirely. The light guide film 12 further includes a triangular prism portion 12b in cross section which is formed so that the thickness of the light guide film 12 at the end edge, at which the at least one thin light source 13 is disposed, increases gradually along the front face toward the end side of the light guide film 12. It should be noted that the expression “substantially rectangular shape” may include not only a normal rectangular shape but also, for example, a quadrangle in which two sides that face each other are arranged with an angle of no greater than 10°, a shape in which one or more corners among the four corners are chamfered, and a shape in which one or more sides among the four sides have a curved portion. Moreover, the expression “end edge of a light guide film” as referred to means a region including a front face and a back face at the end face side of the light guide film, and means, for example, a region extending by no greater than 10 mm in a direction toward the other end face which is opposite to the end face of the light guide film.

The prism portion 12b is formed to a level of at least the height position of the front face of the thin light source 13 from the front face of the main body 12a so as to have a height equal to or greater than the height of the front face. The prism portion 12b has an inclined face 12c that is inclined toward the front face side in a direction along the side of the thin light source 13. The prism portion 12b is formed so that the end face on the side of the thin light source 13 is flush with the end face of the main body 12a. The prism portion 12b can be formed so as to extend from one end of the end edge of the main body 12a on the side of the thin light source 13 toward the other end thereof in the longitudinal direction. Furthermore, the prism portion 12b has a uniform shape in the longitudinally cross sectional plane perpendicular to the end face thereof that faces the thin light source 13.

The prism portion 12b is preferably formed with the same material as the main body 12a. Furthermore, the prism portion 12b is preferably molded integrally with the main body 12a (i.e., molded without via another layer such as an adhesive layer). Since, according to the backlight unit 11, the prism portion 12b is thus molded integrally with the same material as the main body 12a, generation of an interface between the prism portion 12b and the main body 12a can be prevented and the rays of light are enabled to exit from the prism portion 12b and enter the main body 12a easily and reliably.

The lower limit of the lateral length (d) of the bottom portion of the prism portion 12b (the boundary portion with the main body 12a), the lateral length being the length from the end on the side of the thin light source 13 to the end on the side of the other end is preferably 2.5 mm, more preferably 3 mm, and still more preferably 4 mm. On the other hand, the upper limit of the lateral length (d) of the bottom portion of the prism portion 12b is preferably 15 mm, more preferably 10 mm, and still more preferably 7 mm. When the length (d) is less than the lower limit, the inclination angle of the inclined face 12c with respect to the front face of the main body 12a may become so large that it may be difficult to allow the rays of light reflected by the first reflection sheet 14 laminated on the inclined face 12c to suitably propagate into the light guide film 12. To the contrary, when the length (d) is greater than the upper limit, the formation region of the prism portion 12b on the front face of the main body 12a may become so large that a region on the front face of the main body 12a where the rays of light are allowed to exit may not be secured sufficiently.

The lower limit of an inclination angle (α) on the front face of the prism portion 12b with respect to the planar direction of the main body 12a, (the inclination angle of the inclined face 12c) is preferably 10°, more preferably 12°, and still more preferably 15°. On the other hand, the upper limit of the inclination angle (α) on the front face of the prism portion 12b with respect to the planar direction of the main body 12a is preferably 45°, more preferably 40°, and still more preferably 35°. When the inclination angle (α) is less than the above lower limit, the formation region of the prism portion 12b on the front face of the main body 12a may become so large that the region on the front face of the main body 12a where the rays of light are allowed to exit may not be secured sufficiently. To the contrary, when the inclination angle (a) is greater than the upper limit, it may be difficult to allow the rays of light reflected by the first reflection sheet 14 laminated on the inclined face 12c to suitably propagate into the light guide film 12.

The lower limit of the average thickness of the main body 12a is preferably 150 μm, and more preferably 200 μm. The upper limit of the average thickness of the main body 12a is preferably 500 μm, and more preferably 400 μm. When the average thickness of the main body 12a is less than the above lower limit, the strength of the light guide film 12 may be insufficient, and allowing the rays of light of the thin light source 13 to sufficiently enter the light guide film 12 may fail. To the contrary, when the average thickness of the main body 12a is greater than the above upper limit, it may be impossible to use such a light guide film as a thin-film light guide film which is desired for the ultraslim mobile terminal and thus satisfying the requirement of a reduction in thickness of the backlight unit 11 may fail.

The lower limit of an essential light guiding distance of the light guide film 12 from the end face on the side of the thin light source 13 is preferably 7 cm, more preferably 9 cm, and still more preferably 11 cm. On the other hand, the upper limit of the essential light guiding distance of the light guide film 12 from the end face on the side of the thin light source 13 is preferably 25 cm, more preferably 23 cm, and still more preferably 22 cm. When the essential light guiding distance is less than the above lower limit, it may be impossible to use such a light guide film for a large terminal other than a small mobile terminal. To the contrary, when the essential light guiding distance is greater than the above upper limit, a deflection is likely to be caused when such a light guide film is used as a thin-film light guide film having the average thickness of no greater than 600 μm, and light guiding properties thereof may not be secured sufficiently. It should be noted that the essential light guiding distance of the light guide film 12 from the end face on the side of the thin light source 13 as referred to means ae distance required for allowing the rays of light that are emitted from the thin light source 13 and that enter the end face of the light guide film 12 to propagate in a direction from the end face toward the other end face opposite to the end face. More specifically, the essential light guiding distance of the light guide film 12 from the end face on the side of the thin light source 13 as referred to means, for example: a distance of the light guide film from the end face on the side of the thin light source to the other end face opposite to the end face in terms of a unilateral edge-lit backlight unit; and a distance of the light guide film from the end face on the side of the light source to the center thereof in terms of a bilateral edge-lit backlight unit.

The lower limit of the surface area of the light guide film 12 is preferably 150 cm², more preferably 180 cm², and still more preferably 200 cm². On the other hand, the upper limit of the surface area of the light guide film 12 is preferably 760 cm², more preferably 740 cm², and still more preferably 840 cm². When the surface area of the light guide film 12 is less than the above lower limit, it may be impossible to use such a light guide film for a large terminal other than a small mobile terminal. To the contrary, when the surface area of the light guide film 12 is greater than the above upper limit, a deflection is likely to be caused when such a light guide film is used as a thin-film light guide film having the average thickness of no greater than 600 μm, and light guiding properties thereof may not be secured sufficiently.

Since it is necessary for the light guide film 12 to transmit rays of light, the light guide film 12 is formed to be transparent, in particular, formed from a colorless and transparent synthetic resin as a principal component. In particular, a polycarbonate resin or an acrylic resin is preferred as a principal component for the light guide film 12, and polycarbonate is particularly preferred. Since the polycarbonate is highly transparent and a high refractive index, due to the light guide film 12 containing the polycarbonate as a main principal component, a total reflection is likely to occur on the front face and the back face of the light guide film 12, and thus rays of light can propagate efficiently. Furthermore, since the polycarbonate has a heat resistance, deterioration thereof, etc., due to heat generation of the thin light source 13 is less likely to occur. Moreover, since the polycarbonate has inferior water absorbing properties as compared with acrylic resins, it has a high dimensional stability. Therefore, due to the light guide film 12 containing the polycarbonate as a principal component, aging deterioration can be inhibited. On the other hand, since the acrylic resins are highly transparent, a loss of rays of light in the light guide film can be reduced. The light guide film 12 contains the principal component in an amount of preferably no less than 80% by mass, more preferably no less than 90% by mass, and still more preferably no less than 98% by mass.

The polycarbonate is not particularly limited, and may be any one of a linear polycarbonate or a branched polycarbonate alone, or may be a polycarbonate mixture which contains both the linear polycarbonate and the branched polycarbonate.

The linear polycarbonate is exemplified by a linear aromatic polycarbonate produced by a known phosgene method or melting method, and is constituted with a carbonate component and a diphenol component. A precursor in order to introduce the carbonate component is exemplified by phosgene and diphenyl carbonate. Furthermore, examples of diphenol include 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimesyl-4-hydroxyphenyl)cyclohexane, 1,1-bis(4-hydroxyphenyl)decane, 1,1-bis(4-hydroxyphenyl)cyclodecane, 1,1-bis(4-hydroxyphenyl)propane, 1,1-bis(3,5-dimethyl-4-hydroxyphenyl)cyclododecane, 4,4′-dihydroxydiphenyl ether, 4,4′-thiodiphenol, 4,4′-dihydroxy-3,3-dichlorodiphenyl ether. These may be used either alone or in combination of two or more thereof.

The branched polycarbonate is exemplified by polycarbonate produced by a branching agent. Examples of the branching agent include phloroglucin, trimellitic acid, 1,1,1-tris(4-hydroxyphenyl)ethane, 1,1,2-tris(4-hydroxyphenyl)ethane, 1,1,2-tris(4-hydroxyphenyl)propane, 1,1,1-tris(4-hydroxyphenyl)methane, 1,1,1-tris(4-hydroxyphenyl)propane, 1,1,1-tris(2-methyl-4-hydroxyphenyl)methane, 1,1,1-tris(2-methyl-4-hydroxyphenyl)ethane, 1,1,1-tris(3-methyl-4-hydroxyphenyl)methane, 1,1,1-tris(3-methyl-4-hydroxyphenyl)ethane, 1,1,1-tris(3,5-dimethyl-4-hydroxyphenyl)methane, 1,1,1-tris(3,5-dimethyl-4-hydroxyphenyl)ethane, 1,1,1-tris(3-chloro-4-hydroxyphenyl)methane, 1,1,1-tris(3-chloro-4-hydroxyphenyl)ethane, 1,1,1-tris(3,5-dichloro-4-hydroxyphenyl)methane, 1,1,1-tris(3,5-dichloro-4-hydroxyphenyl)ethane, 1,1,1-tris(3-bromo-4-hydroxyphenyl)methane, 1,1,1-tris(3-bromo-4-hydroxyphenyl)ethane, 1,1,1-tris(3,5-dibromo-4-hydroxyphenyl)methane, 1,1,1-tris(3,5-dibromo-4-hydroxyphenyl)ethane, 4,4′-dihydroxy-2,5-dihydroxydiphenyl ether, and the like.

The acrylic resin is exemplified by a resin having a skeleton derived from acrylic acid or methacrylic acid. The acrylic acid is not particularly limited, and examples thereof include poly(meth)acrylic acid esters such as polymethyl methacrylate, methyl methacrylate-(meth)acrylate copolymers, methyl methacrylate-(meth)acrylic acid ester copolymers, methyl methacrylate-acrylic acid ester-(meth)acrylate copolymers, methyl (meth)acrylate-styrene copolymers, polymers having an alicyclic hydrocarbon group (for example, methyl methacrylate-cyclohexyl methacrylate copolymers, methyl methacrylate-norbornyl (meth)acrylate copolymers), and the like. Among these acrylic resins, poly(meth)acrylic acid C1-6 alkyl esters such as poly methyl (meth)acrylate are preferred, and a methyl methacrylate resin is more preferred.

It should be noted that the light guide film 12 may contain an optional component such as an ultraviolet ray absorbing agent, a fire retardant, a stabilizer, a lubricant, a processing aid, a plasticizer, an impact resistance aid, a retardation reducing agent, a delustering agent, an antimicrobial a fungicide, an oxidation inhibitor, a mold releasing agent, and an antistatic agent.

The light guide film 12 preferably has a diffusion pattern composed of a plurality of recessed portions on the back face thereof. The plurality of recessed portions are formed in a scattered dot-like manner on the back face of the light guide film 12. The plurality of recessed portions are provided so as to allow uniform light to exit from the light guide film 12 to the front face side. More specifically, the plurality of recessed portions are formed such that the proportion of the plurality of recessed portions is low at a position near the thin light source 13 and increases as the distance from the thin light source 13 increases. The proportion of the plurality of recessed portions can be regulated by adjusting positions at which the plurality of recessed portions having an identical size are provided, or by changing the sizes of the respective recessed portions.

The shape of the recessed portions is not particularly limited and exemplified by semi-spherical, conular, cylindrical, polygonal pyramidal, polygonal columnar, ungual, or the like. Among these, the recessed portions are preferably formed to have a semi-spherical recess-like portion. When the recessed portions are formed to have a semi-spherical recess-like portion, moldability thereof can be improved thereby enabling the formation of a protruding edge to be prevented, and the reduction in thickness can be promoted.

### First Reflection Tape

The first reflection tape 14 is formed in a substantially rectangular long belt-like shape. The first reflection tape 14 is disposed so as to cover the front face side of a gap X between at least one thin light source 13 and the light guide film 12. Furthermore, the first reflection tape 14 is disposed in parallel with an end side of the light guide film 12. More specifically, the first reflection tape 14 is formed such that one end edge thereof extending in the longitudinal direction is disposed on the front face of the at least one thin light source 13, and the other end edge thereof extending in the longitudinal direction is disposed so as to cover the surface of the prism portion 12b. The first reflection tape 14 is formed so as to extend from one end of an end edge of the light guide film 12 on the side of the thin light source 13 toward the other end thereof in the longitudinal direction. The first reflection tape 14 has flexibility. Since the first reflection tape 14 has flexibility, the first reflection tape 14 can be bent corresponding to shapes of the inclined face 12c of the prism portion 12b, the front face of the thin light source 13, etc., and adhered thereto. It should be noted that the term “elasticity” indicates a characteristic feature of avoiding from generation of a crack when visually observed on a test strip having a width of 10 cm and a length of 20 cm, in the case of being wound around a round bar of 5 cm in diameter in the length direction, for example, and preferably a round bar of 3 cm in diameter.

According to the backlight unit 11, since the first reflection tape 14 is disposed so as to cover the front face side of the gap between the at least one thin light source 13 and the light guide film 12, the rays of light that are emitted from the at least one thin light source 13 and diffused toward the front face side with respect to the end face of the light guide film 12 that faces the thin light source 13 are reflected by the first reflection tape 14 and are enabled to enter the light guide film 12. Furthermore, according to the backlight unit 11, since the refractive index of the light guide film 12 is greater than the refractive index of the air present in the gap X between the at least one thin light source 13 and the light guide film 12, the total reflection of the rays of light reflected by the first reflection tape 14 at an interface of the light guide film 12 and the air can be inhibited, and thus incidence efficiency into the light guide film 12 can be enhanced.

According to the backlight unit 11, since the light guide film 12 further includes the triangular prism portion 12b which is formed so that the thickness of the light guide film 12 at the end edge, at which the at least one thin light source 13 is disposed, increases gradually along the front face toward the end side of the light guide film 12, by means of the prism portion 12b, the area of the end face of the light guide film 12 where the rays of light enter can be increased and thus the rays of light emitted from the thin light source 13 are easily enabled to enter the light guide film. Furthermore, according to the backlight unit 11, since the first reflection tape 14 is disposed so as to cover the surface of the prism portion 12b, the rays of light that are allowed to enter the prism portion 12b can be prevented from being transmitted through the prism portion 12b and directly exiting outside the light guide film 12.

It should be noted that the first reflection tape 14 covers the entire region of the inclined face 12c of the prism portion 12b. According to such a configuration, the backlight unit 11 allows the rays of light that enter the prism portion 12b from the at least one thin light source 13 to enter the main body 12a accurately. Furthermore, the first reflection tape 14 may not cover a region other than the inclined face 12c of the prism portion 12b of the light guide film 12 (i.e., a front face region of the main body 12a). According to such a configuration, the backlight unit 11 allows the rays of light to exit easily from the front face of the main body 12a in a substantially uniform manner.

The first reflection tape 14 includes a reflection layer 18, and an adhesive layer 19 laminated on a back face of the reflection layer 18. The first reflection tape 14 is bonded to the at least one thin light source 13 and the light guide film 12 via the adhesive layer 19. According to the backlight unit 11, since the first reflection tape 14 includes the adhesive layer 19 laminated on the reflection layer 18 and is bonded to the at least one thin light source and the light guide film 12 by means of the adhesive layer 19 as described above, leakage of rays of light from between the first reflection tape 14 and the light guide film 12 can be prevented, and thus the rays of light emitted from the thin light source 13 are enabled to enter the light guide film 12 more accurately. It should be noted that, although the adhesive layer 19 is laminated over the entire back face of the reflection layer 18 in the present embodiment, the adhesive layer 19 may be laminated only on a bonding face between the at least one thin light source 13 and the light guide film 12.

The reflection layer 18 includes a matrix containing a resin as a principal component, and a white pigment included in the matrix. Furthermore, the white pigment is surrounded by the matrix in the reflection layer 18. According to the backlight unit 11, since the reflection layer 18 includes the matrix containing a resin as a principal component, and the white pigment included in the matrix as described above, rays of light that are emitted from the thin light source 13 and are allowed to enter the first reflection tape 14 can be irregularly reflected. Furthermore, according to the backlight unit 11, since the reflection layer 18 includes a matrix containing a resin as a principal component, and a white pigment included in the matrix, a plurality of micro uneven shapes that result from the white pigment are easily formed on the back face of the reflection layer 18, and thus rays of light that are emitted from the thin light source 13 and are allowed to enter the first reflection tape 14 can be diffused adequately by means of the micro uneven shapes. Therefore, according to the backlight unit 11, angles of incidence of rays of light to the light guide film 12 which are reflected by the first reflection tape 14 can be adjusted adequately, and propagation ability in the light guide film 12 of the rays of light that are allowed to enter the light guide film 12 can be improved.

The resin for forming the matrix is not particularly limited, and examples of the resin include polyethylene terephthalate, polyethylene naphthalate, an acrylic resin, polycarbonate, polystyrene, polyolefin, cellulose acetate, weather resistant vinyl chloride, and the like. Among them, polyethylene terephthalate having a superior heat resistance is preferred.

Furthermore, the white pigment is not particularly limited, and is exemplified by titanium oxide (titanium white), zinc oxide (zinc white), lead carbonate (lead white), barium sulfate, calcium carbonate (chalk), and the like.

The lower limit of the average thickness of the reflection layer 18 is preferably 50 μm, more preferably 75 μm, and still more preferably 100 μm. On the other hand, the upper limit of the average thickness of the reflection layer 18 is preferably 300 μm, more preferably 275 μm, and still more preferably 250 μm. When the average thickness of the reflection layer 18 is less than the lower limit, the strength thereof may be insufficient. To the contrary, when the average thickness of the reflection layer 18 is greater than the upper limit, it may be difficult to satisfy a requirement of a reduction in thickness of the mobile terminal 1.

The lower limit of the average particle diameter of the white pigment is preferably 100 nm, more preferably 200 nm, and still more preferably 300 nm. On the other hand, the upper limit of the average particle diameter the white pigment is preferably 30 μm, more preferably 20 μm, and still more preferably 10 μm. When the average particle diameter of the white pigment is less than the lower limit, reflection properties thereof may decrease and the formation of suitable micro uneven shapes on the back face of the reflection layer 18 may be difficult. To the contrary, when the average particle diameter of the white pigment is greater than the above upper limit, the reflection properties may not be uniform. It should be noted that the term “average particle diameter” as referred to means an average value calculated by measuring the lengths of the particle diameters of randomly extracted thirty particles from particles observed by an electron microscope with a magnification of 1,000, and the particle diameter is defined in terms of a Feret diameter (a distance measured when a projected image of a particle is delimited by parallel lines in a predetermined direction).

The lower limit of a content of the white pigment is preferably 3% by mass, more preferably 5% by mass, and still more preferably 7% by mass. On the other hand, the upper limit of the content of the white pigment is preferably 30% by mass, more preferably 25% by mass, and still more preferably 20% by mass. When the content of the white pigment is less than the lower limit, reflection properties thereof may not be secured sufficiently. To the contrary, when the content of the white pigment is greater than the upper limit, dispersibility of the white pigment may decrease and thus the strength of the reflection layer 18 may be impaired.

It should be noted that the reflection layer 18 may contain an optional component such as an ultraviolet ray absorbing agent, a fire retardant, a stabilizer, a lubricant, a processing aid, a plasticizer, an impact resistance aid, a retardation reducing agent, a delustering agent, an antimicrobial a fungicide, an oxidation inhibitor, a mold releasing agent, and an antistatic agent.

An adhesive used for the adhesive layer 19 is not particularly limited, and is exemplified by: an aqueous adhesive or emulsion adhesive including a vinyl acetate resin, a synthetic rubber, polylactic acid, starch, an acrylic resin, etc.: an adhesive including a heat-curable resin such as a urea resin, a melamine resin, a phenol resin, an epoxy resin and a urethane resin; and the like.

The lower limit of the arithmetic average roughness (Ra) of the back face of the reflection layer 18 is preferably 1.5 μm, more preferably 1.7 μm, and still more preferably 2.0 μm. On the other hand, the upper limit of the arithmetic average roughness (Ra) of the back face of the reflection layer 18 is preferably 4.0 μm, more preferably 3.8 μm, and still more preferably 3.5 μm. When the arithmetic average roughness (Ra) of the back face of the reflection layer 18 is less than the lower limit, rays of light that are reflected by the first reflection tape 14 may not be diffused sufficiently, and thus angles of incidence of rays of light to the light guide film 12 which are reflected by the first reflection tape 14 may not be adjusted sufficiently. To the contrary, when the arithmetic average roughness (Ra) of the back face of the reflection layer 18 is greater than the upper limit, the rays of light that are reflected by the first reflection tape 14 may be excessively diffused, and thus propagation of the rays of light in the main body 12a of the light guide film 12 may be difficult. It should be noted that the “arithmetic average roughness (Ra)” is a value measured according to JIS-B0601-1994, with cut-off λc of 2.5 mm and an evaluated length of 12.5 mm.

The lower limit of ten-point average roughness (Rz) of the back face of the reflection layer 18 is preferably 1.5 μm, more preferably 1.7 μm, and still more preferably 2.0 μm. On the other hand, the upper limit of the ten-point average roughness (Rz) of the back face of the reflection layer 18 is preferably 40 μm, more preferably 35 μm, and still more preferably 30 μm. When the ten-point average roughness (Rz) of the back face of the reflection layer 18 is less than the lower limit, rays of light that are reflected by the first reflection tape 14 may not be diffused sufficiently, and angles of incidence of rays of light to the light guide film 12 which are reflected by the first reflection tape 14 may not be adjusted sufficiently. To the contrary, when the ten-point average roughness (Rz) of the back face of the reflection layer 18 is greater than the upper limit, adjustment of the rays of light that are reflected by the first reflection tape 14 may be difficult. It should be noted that the “ten-point average roughness (Rz)” is a value measured according to JIS-B0601-1994.

The lower limit of the ratio (Rz/Ra) of the ten-point average roughness (Rz) to the arithmetic average roughness (Ra) of the back face of the reflection layer 18 is preferably 1. On the other hand, the upper limit of the ratio (Rz/Ra) of the ten-point average roughness (Rz) to the arithmetic average roughness (Ra) of the back face of the reflection layer 18 is preferably 20, more preferably 15, and still more preferably 10. When the ratio (Rz/Ra) of the ten-point average roughness (Rz) to the arithmetic average roughness (Ra) of the back face of the reflection layer 18 is greater than the upper limit, lack in uniformity of the micro uneven shapes may increase and thus diffused rays of light may not be secured suitably.

The second reflection tape 15 is formed in a substantially rectangular long belt-like shape. The second reflection tape 15 is disposed so as to cover the back face side of the gap X between at least one thin light source 13 and the light guide film 12. Furthermore, the second reflection tape 15 is disposed in parallel with an end side of the light guide film 12 at which the at least one thin light source 13 is disposed. The second reflection tape 15 is formed so as to extend from one end of an end edge of the light guide film 12 on the side of the thin light source 13 toward the other end thereof in the longitudinal direction. The second reflection tape 15 has flexibility. The second reflection tape 15 is formed such that one end edge thereof extending in the longitudinal direction is disposed on the back face of the at least one thin light source 13, and the other end edge thereof extending in the longitudinal direction is disposed on the back face of the main body 12a. Furthermore, the other end edge of the second reflection tape 15 extending in the longitudinal direction corresponds to the other end edge of the first reflection tape 14 extending in the longitudinal direction in a planar view. Accordingly, the backlight unit 11 is capable of reflecting rays of light emitted from the at least one thin light source 13 accurately, with a region in which the first reflection tape 14 and the second reflection tape 15 are present in the light guide film 12 in a planar view as a reflection region. The backlight unit 11 also enables the rays of light to exit in a substantially uniform manner from a region from which rays of light arranged by the region in which the first reflection tape 14 and the second reflection tape 15 are not present in a planar view are allowed to exit. However, in the backlight unit 11, the other end edge of the second reflection tape 15 extending in the longitudinal direction may extend inside with respect to the other end edge of the first reflection tape 14 in the longitudinal direction (the side of an end face opposite to the end face that faces the at least one thin light source 13). With such a configuration, the rays of light reflected by the second reflection tape 15 are easily allowed to exit from the region from which the rays of light are allowed to exit.

When the backlight unit 11 includes the second reflection tape 15, rays of light that are emitted from the at least one thin light source 13 and diffused toward the back face side with respect to the end face of the light guide film 12 which faces the thin light source 13 are reflected by the second reflection tape 15 and are enabled to enter the light guide film 12. Furthermore, according to the backlight unit 11, since the refractive index of the light guide film 12 is greater than the refractive index of the air present in the gap X between the at least one thin light source 13 and the light guide film 12, the total reflection of the rays of light reflected by the second reflection tape 15 at the interface of the light guide film and the air can be inhibited, and thus incidence efficiency into the light guide film 12 can be enhanced. In particular, since the backlight unit 11 includes the second reflection tape 15 in addition to the first reflection tape 14, leakage of rays of light from the gap X between the at least one thin light source 13 and the light guide film 12 can be further prevented easily and securely.

The second reflection tape 15 includes a reflection layer 20, and an adhesive layer 21 laminated on a front face of the reflection layer 20. The second reflection tape 15 is bonded to the at least one thin light source 13 and the light guide film 12 via the adhesive layer 21. According to the backlight unit 11, since the second reflection tape 15 is bonded to the at least one thin light source 13 and the light guide film 12 by means of the adhesive layer 21 as described above, leakage of rays of light from between the second reflection tape 15 and the light guide film 12 can be prevented and thus the rays of light emitted from the thin light source 13 are enabled to enter the light guide film 12 more accurately.

The reflection layer 20 of the second reflection tape 15 may be configured to have a structure similar to that of the reflection layer 18 of the first reflection tape 14. Also, the adhesive layer 21 of the second reflection tape 15 may be configured to have a structure similar to the adhesive layer 19 of the first reflection tape 14. Moreover, the arithmetic average roughness (Ra) of the front face of the reflection layer 20, the ten-point average roughness (Rz) of the front face of the reflection layer 20, and the ratio (Rz/Ra) of the ten-point average roughness (Rz) to the arithmetic average roughness (Ra) of the front face of the reflection layer 20 may be similar to those of the back face of the reflection layer 18 of the first reflection tape 14.

### Thin Light Source

The at least one thin light source 13 is disposed so as to face at least one end face of the light guide film 12, and in the present embodiment, disposed so as to face one end face of the light guide film 12. The thin light source 13 is disposed such that a face from which rays of light exit faces the end face of the light guide film 12. The height position of a front face of the thin light source 13 is equal to or lower than the height position of the end of the prism portion 12b of the light guide film 12 on the side of the thin light source 13, and the height position of the back face of the thin light source 13 is equal to the height position of the back face of the light guide film 12. Various types of light sources can be used as the thin light source 13, which may be exemplified by a thin light emitting diode (LED) element. Furthermore, such a thin LED element may include at least one light emitting diode (LED) and a casing that surrounds the same. It should be noted that “thin light source” as referred to means, for example, a light source having the average height of no greater than 1 mm, preferably a light source having the average height of an effective face from which rays of light exit (for example, an opening of a casing that surrounds a light source) of no greater than 1.5 mm, more preferably a light source having the average height of the effective face from which rays of light exit of no greater than 800 μm, and still more preferably a light source having the average height of the effective face from which rays of light exit of no greater than 600 μm.

The thin light source 13 is spaced away from the end face of the light guide film 12 which the thin light source 13 faces. The lower limit of the average interval between the thin light source 13 and the end face of the light guide film 12 is preferably 30 μm, and more preferably 50 μm. On the other hand, the upper limit of the average interval between the thin light source 13 and the end face of the light guide film 12 is preferably 2 mm, and more preferably mm. When the average interval between the thin light source 13 and the light guide film 12 is less than the lower limit, angles of incidence of rays of light to the light guide film 12 which are emitted from the thin light source and reflected by the first reflection tape 14 or the second reflection tape 15 are likely to become small, allowing the rays of light reflected by the first reflection tape 14 or the second reflection tape 15 to enter the light guide film 12 may be difficult. To the contrary, when the average interval between the thin light source 13 and the light guide film 12 is greater than the upper limit, the backlight unit 11 may become large unnecessarily and reflection loss thereof may increase.

### Reflection Sheet

The reflection sheet 16 allows rays of light that are allowed to exit from the back face side of the light guide film 12 to be reflected toward the front face side. The reflection sheet 16 is exemplified by a white sheet in which a filler is contained in a dispersion state in a base resin such as a polyester-based resin, a mirror sheet obtained by vapor deposition of a metal such as aluminum and silver on the front face of a film made of a polyester-based resin or the like to enhance regular reflection properties, and the like.

### Optical Sheet

The optical sheet 17 has optical functions such as diffusion and refraction with respect to rays of light allowed to enter from the back face side. The optical sheet 17 is exemplified by a light diffusion sheet having a light diffusion function, a prism sheet having a refractive function in a normal direction, and the like.

### Production Method

### Production Method of Light Guide Film

Next, a production method of the light guide film 12 will be described. The light guide film 12 is molded by an extrusion molding technique, for example.

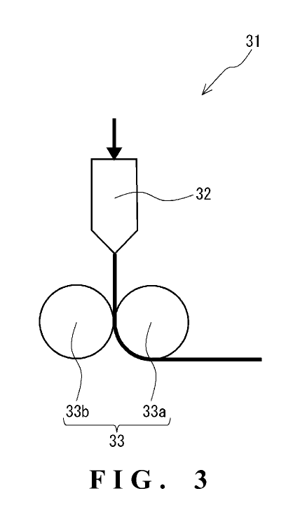

The production method when producing the light guide film 12 by means of the extrusion molding technique includes a step of molding a film (STEP 1), a step of forming a diffusion pattern on the back face (STEP 2), and a step of forming the prism portion 12b on the front face (STEP 3). STEP 1 to STEP 3 are performed at once by using an extrusion molding apparatus 31 of FIG. 3. It should be noted that STEP 2 will be omitted when not forming a diffusion pattern on the back face of the light guide film 12.

The extrusion molding apparatus 31 includes an extruder and a T die 32, a pair of pressure rolls 33, and a winding system (not illustrated), for example. Known dies such as a fish-tail die, a manifold die and a coat hanger die can be used as the T die 32. The pair of pressure rolls 33 is disposed to be adjacent and in parallel with each other. The extruder and the T die 32 are configured so as to be able to extrude a molten resin in a sheet-like shape at a nipping portion of the pair of pressure rolls 33. The pair of pressure rolls 33 is provided with a temperature control means and thus is configured so as to be able to maintain a surface temperature thereof at an optimal temperature during extrusion molding. A metal elastic roll composed of a metal roll and a flexible roll covered with an elastic body on the surface is preferably used as the pressure rolls 33.

The pair of pressure rolls 33 is disposed so that a pressure roll 33a faces a pressure roll 33b. The pressure roll 33a is formed as a reverse mold having a reversed pattern of a diffusion pattern on the surface thereof. Furthermore, a recessed portion is formed which corresponds to the prism portion 12b on the surface of the pressure roll 33b.

STEP 1 is performed by a melt extrusion molding technique which includes supplying a material for forming the light guide film 12 in a molten state with the T die 32, extruding the material for forming the light guide film 12 from the extruder and the T die 32, and pressing the material through the pair of pressure rolls 33. It should be noted that the melt temperature of the material for forming the light guide film 12 which is extruded from the T die 32 is chosen appropriately taking into consideration of a melting point of a resin used, and the like. The average thickness of the light guide film 12 is adjusted, for example, by adjusting intervals at which the pair of pressure rolls 33 is disposed.

STEP 2 is performed by transferring the reversed pattern of the diffusion pattern on the surface of the pressure roll 33a before the material for forming the light guide film 12 in a molten state is hardened. In STEP 2, the material for forming the light guide film 12 in a molten state is pressed by the pair of pressure rolls 33 so that the reversed pattern of the diffusion pattern on the surface of the pressure roll 33a is transferred to the back face of the light guide film 12. In STEP 2, a diffusion pattern is formed on the back face of the light guide film 12 by means of this transfer.

STEP 3 is performed at the same time as STEP 2. STEP 3 is performed by allowing the material for forming the light guide film 12 in a molten state to be introduced into the recessed portions which are formed on the surface of the pressure roll 33b and curing the material while maintaining the state of the material being introduced.

It should be noted that although STEP 1, STEP 2, and STEP 3 can be performed in an in-line measurement manner as described above, they may also be performed in an off-line measurement manner.

### Production Method of Reflection Tape

A production method of the first reflection tape 14 and the second reflection tape 15 includes a step of extruding a material for forming the reflection layers 18 and 20 including a synthetic resin which forms a matrix made of a resin, and a white pigment from the extruder and the T die, and stretching the material at a predetermined stretching magnification (STEP 11), a step of laminating adhesive layers 19 and 21 by coating on one face of an extruded body molded in STEP 11 (STEP 12), and a step of cutting a laminated body formed in STEP 12 to a predetermined size (STEP 13).

Furthermore, upon manufacturing the first reflection tape 14 and the second reflection tape 15, a step of performing matt finish on the back face may be included in order to form preferable micro uneven shapes.

Advantages

Since rays of light emitted from a light source such as an LED are generally diffused rays of light, some of the rays of light emitted from the light source in an edge-lit backlight unit are lost because they are not allowed to enter an end face of a light guide film or do not propagate appropriately in the light guide film. Furthermore, such a loss of rays of light is more significant as a reduction in thickness of the light guide film is promoted. To the contrary, since the edge-lit backlight unit 11 includes the first reflection tape 14 that is disposed so as to cover the front face side of the end edge on the side of the at least one thin light source 13 of the light guide film 12, rays of light emitted from the at least one thin light source 13 are reflected by the first reflection tape 14, and the rays of light reflected by the first reflection tape 14 are then enabled to enter the light guide film 12. Therefore, according to the edge-lit backlight unit 11, even when the average thickness of the light guide film 12 falls within a range of no less than 100 μm and no greater than 600 μm and thus is relatively small, the utilization efficiency of rays of light can be enhanced and thus the improvement of luminance can be promoted, by allowing the rays of light emitted from the at least one thin light source 13 to enter the light guide film 12 accurately.

The reflection tape members (the first reflection tape 14 and the second reflection tape 15) allow rays of light emitted from the thin light source 13 to enter the light guide film 12.

Since the mobile terminal 1 includes the backlight unit 11, the utilization efficiency of light can be enhanced and thus the improvement of luminance can be promoted, by allowing the rays of light emitted from the at least one thin light source 13 to enter a light guide film 12 accurately.

### Second Embodiment

A backlight unit according to the second embodiment of the present invention will be described with reference to FIG. 2. The backlight unit according to the second embodiment of the present invention is configured similarly to the backlight unit 11 of FIG. 2 except for an adhesive used for the adhesive layer 19 of the first reflection tape 14 and the adhesive layer 21 of the second reflection tape 15 differing. An adhesive that can bond the first reflection tape 14 and the second reflection tape 15 to the at least one thin light source 13 and the light guide film 12 in a temporarily adhered state is used as an adhesive used for the adhesive layer 19 of the first reflection tape 14 and the adhesive layer 21 of the second reflection tape 15 of the backlight unit. Such an adhesive is exemplified by a pressure-sensitive adhesive containing as a principal polymer, for example, an acrylic resin, methacrylic resin, methacrylate resin, butyl rubber, or silicone resin.

Advantages

According to the backlight unit, since the first reflection tape 14 and the second reflection tape 15 are bonded to the at least one thin light source 13 and the light guide film 12 in a temporarily adhered state, leakage of rays of light from between the first reflection tape 14 and the second reflection tape 15, and the light guide film 12 can be prevented, and the disposition and replacement of the first reflection tape 14 and the second reflection tape 15 can be easily performed.

### Third Embodiment

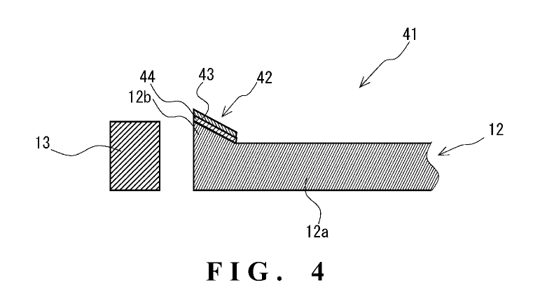

A backlight unit 41 of FIG. 4 is provided to a liquid crystal display unit 3 of the ultraslim computer 1. The backlight unit 41 includes a light guide film 12, at least one thin light source 13 as a light source that allows rays of light to enter an end face of the light guide film 12, and a first reflection tape 42 that is disposed so as to cover a front face side of an end edge on the side of the at least one thin light source 13 of the light guide film 12. Furthermore, the backlight unit 41 may include in addition to the light guide film 12, the at least one thin light source 13 and the first reflection tape 42, a reflection sheet that is disposed on a back face side of the light guide film 12, and an optical sheet that is disposed on a front face side of the guide film 12i. The backlight unit 41 allows rays of light emitted from the at least one thin light source 13 to exit in a substantially uniform manner from the front face of the light guide film 12. Since the light guide film 12 and the thin light source 13 in the backlight unit 41 are similar to those in the backlight unit of FIG. 2, the same reference numerals are attached thereto and the descriptions therefor will be omitted.

The first reflection tape 42 includes a reflection layer 43, and an adhesive layer 44 that is laminated on a back face of the reflection layer 43. The first reflection tape 42 is bonded so as to cover the surface of the prism portion 12b by means of the adhesive layer 44. It should be noted that the first reflection tape 42 is disposed only in a region overlapping with the prism portion 12b in a planar view in the present embodiment. The first reflection tape 42 is configured similarly to the first reflection tape 14 of FIG. 2 except for the disposed location thereof differing.

### Advantages

According to the backlight unit 41, the utilization efficiency of rays of light can be enhanced and thus the improvement of luminance can be promoted, by allowing the rays of light emitted from the thin light source 13 to enter a light guide film 12 accurately. Since, according to the backlight unit 41, the area of an end face of the light guide film 12 where the rays of light enter can be increased by means of the prism portion 12b and thus the rays of light emitted from the thin light source 13 are easily enabled to enter the light guide film 12, and the first reflection tape 42 is further disposed so as to cover the surface of the prism portion 12b, the rays of light that are allowed to enter the prism portion 12b can be prevented from being transmitted through the prism portion 12b and directly exiting outside the light guide film 12.

### Other Embodiments

It should be noted that the edge-lit backlight unit and the reflection tape member according to the embodiments of the present invention can be put into practice in various modes with modifications and improvements as well as the above-described embodiments. For example, the backlight unit does not necessarily include the reflection sheet or the optical sheet. Also, the backlight unit does not necessarily include both the first reflection tape and the second reflection tape but may include the first reflection tape solely. Moreover, even when the backlight unit includes the first reflection tape and the second reflection tape, the structure of the first reflection tape may differ from that of the second reflection tape, and, for example, either the first reflection tape or the second reflection tape may be configured so as to be in a temporarily adhered manner. In addition, the light guide film does not necessarily include a prism portion, and may be configured with a main body solely formed in a substantially rectangular plate-like shape in a planar view. Furthermore, the triangular prism portion is not necessarily formed in a triangle shape in cross section. The cross sectional shape of the prism portion may be, for example, a trapezoid with an interface with the main body as a bottom base, or a shape having a rectangular portion in cross section, which is continuous to a region of the triangle shape in cross section and extends toward a side of the at least one thin light source.

In the first reflection tape and/or the second reflection tape, the reflection layer thereof does not necessarily include a matrix, and a white pigment included in the matrix, but the reflection layer may be composed of a metal foil or metal plate, for example. Furthermore, the first reflection tape and/or the second reflection tape may include: a substrate layer formed from a white synthetic resin, for example; and a light diffusion layer that is laminated on an inner face of the substrate layer (a face on a side facing a thin light source) and contains a filler, and a binder that covers the filler. When the first reflection tape and/or the second reflection tape include such a configuration, rays of light reflected by the substrate layer can be diffused by the light diffusion layer. Therefore, angles of incidence of the rays of light to the light guide film that are reflected by the first reflection tape and/or the second reflection tape can be adjusted adequately, and propagation ability in the light guide film of the rays of light that are allowed to enter the light guide film can be enhanced. The first reflection tape and/or the second reflection tape may not be necessarily formed so as to extend from one end of an end edge of the light guide film on the side of the thin light source toward the other end thereof in the longitudinal direction, and thus may be disposed at each of disposed locations of the thin light sources, for example.

Furthermore, although the configurations are described in the aforementioned embodiments in which the prism portion is formed with the same material as the main body, the prism portion may be formed with a different material from that of the main body. In a case in which the prism portion is formed with a material different from that of the main body, a principal component forming the prism portion is exemplified by an active energy ray-curable resin and a thermosetting resin. In particular, an ultraviolet ray-curable resin is preferred as a principal component forming the prism portion. Moldability by coating of the prism portion can be improved by using the ultraviolet ray-curable resin as a principal component forming the prism portion.

The ultraviolet ray-curable resin is exemplified by a urethane acrylate-based resin, a polyester acrylate-based resin, an epoxy acrylate-based resin, a polyol acrylate-based resin, and an epoxy resin. Among these, an acrylate based resin is preferred, and polyfunctional acrylate is particularly preferred.

Examples of the polyfunctional acrylate include pentaerythritol acrylate, dipentaerythritol acrylate, pentaerythritol methacrylate, dipentaerythritol methacrylate, and the like. It should be noted that the “polyfunctional acrylate” as referred to means a compound having two or more acryloyloxy groups or methacryloyloxy groups in a molecule.

Examples of polyfunctional acrylate monomer include ethylene glycol diacrylate, diethylene glycol diacrylate, 1,6-hexanediol diacrylate, neopentyl glycol diacrylate, trimethylolpropane triacrylate, trimethylolethane triacrylate, tetramethylolmethane triacrylate, tetramethylolmethane tetraacrylate, pentaglycerol triacrylate, pentaerythritol diacrylate, pentaerythritol triacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris(acryloyloxyethyl)isocyanurate, ethylene glycol dimethacrylate, diethylene glycol dimethacrylate, 1,6-hexanediol dimethacrylate, neopentyl glycol dimethacrylate, trimethylolpropane trimethacrylate, trimethylolethane trimethacrylate, tetramethylolmethane trimethacrylate, tetramethylolmethane tetramethacrylate, pentaglycerol trimethacrylate, pentaerythritol dimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate, dipentaerythritol hexamethacrylate, isoboronyl acrylate, and the like. These compounds may be used either alone, or as a mixture of two or more types thereof. Also, the compound may be an oligomer, such as a dimer or a trimer, of the monomer.

Furthermore, a material for forming the prism portion preferably contains a photopolymerization initiator for promoting curing of the ultraviolet ray-curable resin.

The photopolymerization initiator is exemplified by acetophenone, benzophenone, hydroxybenzophenone, a Michler ketone, an α-amyloxime ester, thiaxanthon and derivatives of the same.

The content of the photopolymerization initiator with respect to 100 parts by mass of the ultraviolet ray-curable resin may fall within a range of no less than 0.01 parts by mass and no greater than 20 parts by mass, for example.

It should be noted that the prism portion may contain an optional component such as an ultraviolet ray absorbing agent, a fire retardant, a stabilizer, a lubricant, a processing aid, a plasticizer, an impact resistance aid, a retardation reducing agent, a delustering agent, an antimicrobial a fungicide, an oxidation inhibitor, a mold releasing agent, and an antistatic agent.

In a case in which the main body is formed with a material different from that of the prism portion, the lower limit of the difference between the refractive index (n₁) of the main body and the refractive index (n₂) of the prism portion is preferably 0.05, more preferably 0.07, and still more preferably 0.09. On the other hand, the upper limit of the difference between the refractive index (n₁) of the main body and the refractive index (n₂) of the prism portion is preferably 0.15, more preferably 0.13, and still more preferably 0.11. When the difference between the refractive index (n₁) of the main body and the refractive index (n₂) of the prism portion falls within the above range, refraction of rays of light reflected by the first reflection sheet laminated on the inclined face thereof is enabled toward a back face side thereof adequately at the interface of the prism portion and the main body. Accordingly, the rays of light are allowed to exit suitably from a region on the side of the thin light source in the region of a main body surface from which the rays of light are allowed to exit, and uniformity of luminance can be improved.

It should be noted that a production method of a light guide film in a case in which the main body of the light guide film is formed with a material different from that of the prism portion is exemplified by a method of coating a material for forming the prism portion to the main body surface, for example.

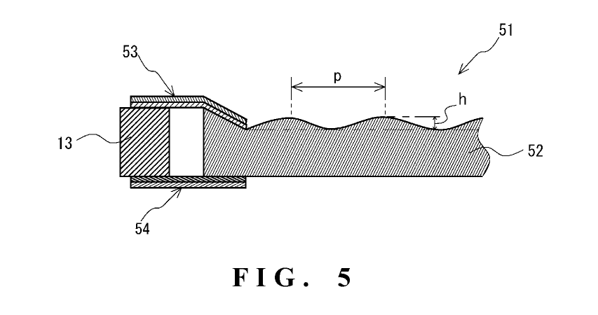

The light guide film used for the backlight unit may have a microundulation on a front face of the main body. FIG. 5 illustrates a structure having such a microundulation. A backlight unit 51 of FIG. 5 includes a light guide film 52, at least one thin light source 13 that allows rays of light to enter an end face of the light guide film 52, a first reflection tape 53 that is disposed in parallel with an end side of the light guide film 52 and disposed so as to cover a front face side of a gap between the at least one thin light source 13 and the light guide film 52, a second reflection tape 54 that is disposed in parallel with an end side of the light guide film 52 at which the at least one thin light source 13 is disposed and disposed so as to cover a back face side of the gap between the at least one thin light source 13 and the light guide film 52, a reflection sheet (not illustrated) disposed on a back face side of the light guide film 52, and an optical sheet (not illustrated) disposed on a front face side of the light guide film 52. The backlight unit of FIG. 5 has a structure similar to that of the backlight unit 11 of FIG. 2 except for having the microundulation on a surface of the main body of the light guide film 52.

The microundulation is disposed such that the direction of ridge lines of the microundulation is in parallel with an end face of the light guide film 52 that the thin light source 13 faces. With such a configuration, since the direction of ridge lines of the microundulation is substantially vertically with respect to a travelling direction of rays of light propagating in the light guide film 52, light emission properties from the front face of the light guide film 52 can be improved due to variation of angles of incidence of the rays of light that enter the front face thereof by means of the microundulation. Furthermore, the lower limit of an interval p between the ridge lines of the microundulation is preferably 1 mm, more preferably 10 mm, and still more preferably 20 mm. On the other hand, the upper limit of the interval p between the ridge lines of the microundulation is preferably 500 mm, more preferably 100 mm, and still more preferably 60 mm. When the interval p between the ridge lines is less than the lower limit, rays of light may be allowed to exit excessively from the front face of the light guide film 52. On the other hand, when the interval p between the ridge lines is greater than the upper limit, the effects of the improvement of light emission properties of the light guide film 52 may be inferior. It should be noted that, although all of the intervals p between the ridge lines of the microundulation preferably fall within the above range, some of a plurality of the intervals p between the ridge lines of the microundulation may not fall within the above range. In such a case, no less than 50% of a plurality of the intervals between the ridge lines may fall within the above range, and no less than 70% of a plurality of the intervals between the ridge lines may preferably fall within the above range.

The lower limit of the average height h of the ridge lines from the base, being an approximate hypothetical plane of the microundulation on which a plurality of valley lines run, is preferably 5 μm, more preferably 7 μm, and still more preferably 9 μm. On the other hand, the upper limit of the average height h of the ridge lines from the base, being the approximate hypothetical plane of the microundulation on which a plurality of valley lines run, is preferably 40 μm, more preferably 20 μm, and still more preferably 15 μm. When the average height h is less than the lower limit, the effects of the improvement of light emission properties of the light guide film 52 may be inferior. To the contrary, when the average height h is greater than the upper limit, rays of light may be allowed to excessively exit from the front face of the light guide film 52.

It should be noted that the direction of the ridge lines of the microundulation may be substantially perpendicular to the end face of the light guide film 52 that the thin light source 13 faces. With such a configuration, when the rays of light propagating through the light guide film 52 are reflected on the front face thereof, a travelling direction of some of the rays of light is shifted to the side of the ridge line, and thus the rays of light are likely to be condensed on the side of the direction of the ridge lines. Furthermore, in addition to this, since the rays of light that are allowed to exit from the front face thereof are slightly diffused in a direction perpendicular to the direction of the ridge lines due to the refraction on the microundulation, diffusion properties of the rays of light that are allowed to exit may be improved. Furthermore, the intervals p between the ridge lines of the microundulation and the average height h of the ridge lines from the base, being an approximate hypothetical plane of the microundulation on which a plurality of valley lines run, in a case in which the direction of the ridge lines of the microundulation is substantially perpendicular to the end face of the light guide film 52 that the thin light source 13 faces may be similar to those in the case in which the direction of the ridge lines of the microundulation is in parallel with the end face of the light guide film 52 that the thin light source 13 faces.

It should be noted that, when molding the light guide film 52 by an extrusion molding technique, the microundulation can be formed by using a die of a lip opening having a specific cross sectional shape. More specifically, a microundulation can be formed on at least one face side of the light guide film 52 by using a die having the cross sectional shape of the lip opening corresponding to the reverse shape of the microundulation.

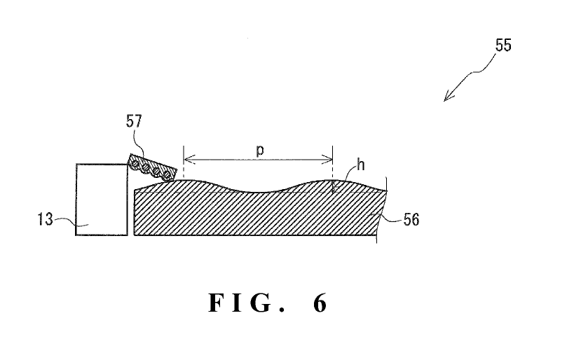

Furthermore, the backlight unit having the microundulation on the front face of the main body of the light guide film is also exemplified by a backlight unit 55 illustrated in FIG. 6. The backlight unit of FIG. 6 includes a light guide film 56 configured with a main body solely, the at least one thin light source 13 that is disposed so as to face at least one end face of the light guide film 56, and a first reflection tape 57 that is disposed so as to cover a front face side of a gap between the at least one thin light source 13 and the light guide film 56. According to the backlight unit 55, the direction of ridge lines of the microundulation is in parallel with the end face of the light guide film 56 that the thin light source 13 faces. Furthermore, the first reflection tape 57 includes a matrix containing a resin as a principal component, and a white pigment included in the matrix.

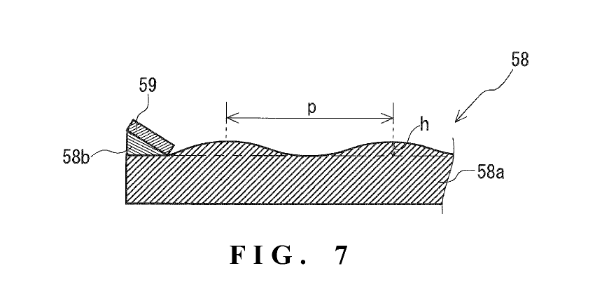

Furthermore, the light guide film having the microundulation on the front face of the main body is also exemplified by a light guide film 58 illustrated in FIG. 7. The light guide film 58 of FIG. 7 includes a main body 58a and a triangular prism portion 58b which is formed with a material different from that of the main body 58a and is formed such that the thickness of the light guide film 58 at the end edge, at which the at least one thin light source is disposed, increases gradually along the front face toward the end side of the light guide film 58. A first reflection tape 59 is disposed on the front face of the prism portion 58b.

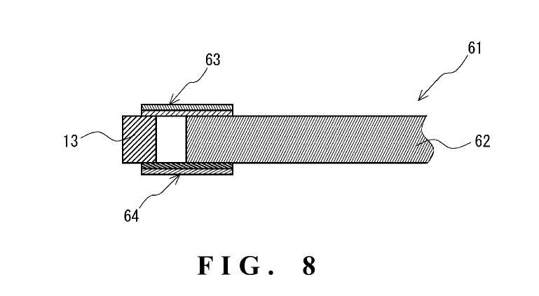

Furthermore, for the configurations of the light guide film, the at least one thin light source, the first reflection tape, and the second reflection tape in the backlight unit, for example, the configurations illustrated in FIGS. 8 to 14, can be adopted.

A backlight unit 61 of FIG. 8 includes a light guide film 62, at least one thin light source 13 that allows rays of light to enter an end face of the light guide film 62, a first reflection tape 63 that is disposed in parallel with an end side of the light guide film 62 and disposed so as to cover a front face side of a gap between the at least one thin light source 13 and the light guide film 62, and a second reflection tape 64 that is disposed in parallel with the end side of the light guide film 62 at which the at least one thin light source 13 is disposed and disposed so as to cover a back face side of the gap between the at least one thin light source 13 and the light guide film 62. The light guide film 62 is configured with a main body solely, and the height position of a front face of the main body is substantially equal to the height position of a front face of the thin light source 13, and the height position of a back face of the main body is substantially equal to the height position of a back face of the thin light source 13. According to the backlight unit 61, with such a configuration as well, rays of light emitted from the at least one thin light source 13 are allowed to enter the light guide film 62 accurately, whereby the utilization efficiency of rays of light can be enhanced and thus the improvement of luminance can be promoted.

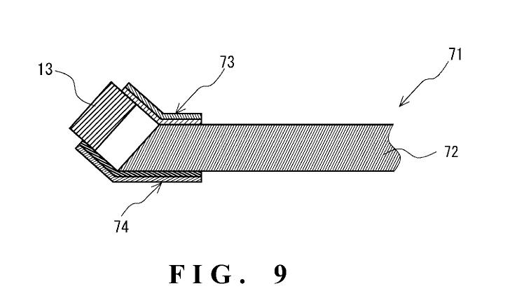

A backlight unit 71 of FIG. 9 includes a light guide film 72, at least one thin light source 13 that allows rays of light to enter an end face of the light guide film 72, a first reflection tape 73 that is disposed in parallel with an end side of the light guide film 72 and disposed so as to cover a front face side of a gap between the at least one thin light source 13 and the light guide film 72, and a second reflection tape 74 that is disposed in parallel with the end side of the light guide film 72 at which the at least one thin light source 13 is disposed and disposed so as to cover a back face side of the gap between the at least one thin light source 13 and the light guide film 72. The light guide film 72 is configured with a main body solely, and an end face thereof that the at least one thin light source 13 faces is inclined toward the outside from the front face side over the back face side. According to the backlight unit 71 with such a configuration, the area of an end face of the light guide film 72 where the rays of light enter can be increased, and the rays of light emitted from the at least one thin light source 13 are allowed to enter the light guide film 72 efficiently, whereby the utilization efficiency of rays of light can be enhanced and thus the improvement of luminance can be promoted.

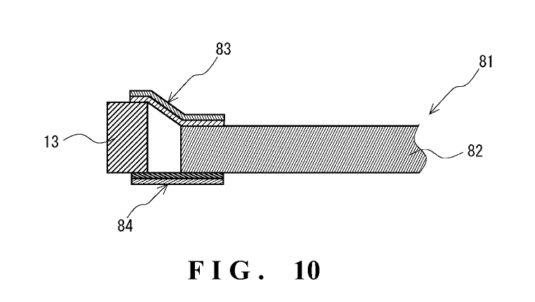

A backlight unit 81 of FIG. 10 includes a light guide film 82, at least one thin light source 13 that allows rays of light to enter an end face of the light guide film 82, a first reflection tape 83 that is disposed in parallel with an end side of the light guide film 82 and disposed so as to cover a front face side of a gap between the at least one thin light source 13 and the light guide film 82, and a second reflection tape 84 that is disposed in parallel with the end side of the light guide film 82 at which the at least one thin light source 13 is disposed and disposed so as to cover a back face side of the gap between the at least one thin light source 13 and the light guide film 82. According to the backlight unit 81, the light guide film 82 is configured with a main body solely, and the height position of a front face of the at least one thin light source 13 is higher than the height position of a front face of the light guide film 82. According to the backlight unit with such a configuration, in general, rays of light emitted from at least one thin light source are not allowed to enter a light guide film and thus are likely to be diffused on the front face side with respect to the end face of the light guide film that faces the thin light source. To the contrary, since the backlight unit 81 includes the first reflection tape 83 and the second reflection tape 84, rays of light emitted from the at least one thin light source 13 are allowed to enter the light guide film 82 efficiently, whereby the utilization efficiency of rays of light can be enhanced and thus the improvement of luminance can be promoted.

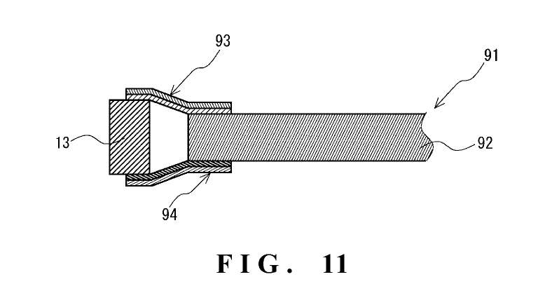

A backlight unit 91 of FIG. 11 includes a light guide film 92, at least one thin light source 13 that allows rays of light to enter an end face of the light guide film 92, a first reflection tape 93 that is disposed in parallel with an end side of the light guide film 92 and disposed so as to cover a front face side of a gap between the at least one thin light source 13 and the light guide film 92, and a second reflection tape 94 that is disposed in parallel with the end side of the light guide film 92 at which the at least one thin light source 13 is disposed and disposed so as to cover a back face side of the gap between the at least one thin light source 13 and the light guide film 92. According to the backlight unit 91, the light guide film 92 is configured with a main body solely, the height position of a front face of the at least one thin light source 13 is higher than the height position of a front face of the light guide film 92, and the height position of a back face side of the at least one thin light source 13 is lower than the height position of a back face of the light guide film 92. According to the backlight unit with such a configuration, rays of light emitted from at least one thin light source are normally not allowed to enter a light guide film and thus are likely to be diffused on the front face side or the back face side with respect to the end face of the light guide film that faces the thin light source. To the contrary, since the backlight unit 91 includes the first reflection tape 93 and the second reflection tape 94, rays of light emitted from the at least one thin light source 13 are allowed to enter the light guide film 92 efficiently, whereby the utilization efficiency of rays of light can be enhanced and thus the improvement of luminance can be promoted.

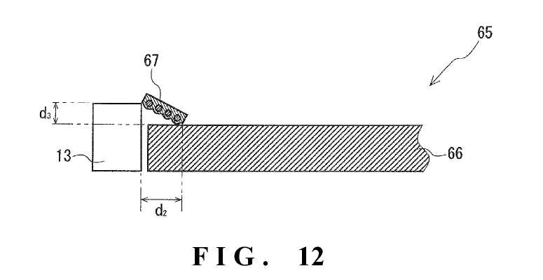

A backlight unit 65 of FIG. 12 includes a light guide film 66, at least one thin light source 13 that allows rays of light to enter an end face of the light guide film 66, a first reflection tape 67 that is disposed in parallel with an end side of the light guide film 66 and disposed so as to cover a front face side of a gap between the at least one thin light source 13 and the light guide film 66. The light guide film 66 is configured with a main body solely, and the height position of a front face of the at least one thin light source 13 is higher than the height position of a front face of the light guide film 66. The first reflection tape 67 includes a matrix containing a resin as a principal component, and a white pigment included in the matrix. Furthermore, a hollow region is formed between the first reflection tape 67 and the front face of the light guide film 66.

The reference symbol d₂ denotes a distance in a planar direction from the thin light source 13 to a bonded part between the first reflection tape 67 and the light guide film 66. The reference symbol d₃ denotes a vertical distance from a front face of the light guide film 66 to a front face of the at least one thin light source 13. Here, the lower limit of the ratio of d₃/d₂ is preferably 1/5, more preferably 3/10, and still more preferably 2/5. On the other hand, the upper limit of the ratio of d₃/d₂ is preferably 1, more preferably 9/10, and still more preferably 4/5. When the distance ratio d₃/d₂ is less than the lower limit, a planar region of the light guide film 66 covered by the first reflection tape 67 is greater such that a front face of a region of the light guide film 66 that allows rays of light to exit may not be secured sufficiently. To the contrary, when the distance ratio d₃/d₂ is greater than the upper limit, allowing the rays of light reflected by the first reflection tape 67 to suitably enter the light guide film 66 may fail.

According to the backlight unit 65 with such a configuration as well, rays of light emitted from the at least one thin light source 13 are allowed to enter the light guide film 66 accurately, whereby the utilization efficiency of rays of light can be enhanced and thus the improvement of luminance can be promoted. Furthermore, according to the backlight unit 65, since a hollow region is formed between a front face of the light guide film 66 and a back face of the first reflection tape 67, and the refractive index of the light guide film 66 is greater than the refractive index of the air, the rays of light are more likely to be allowed to enter the light guide film 66 from the hollow region.

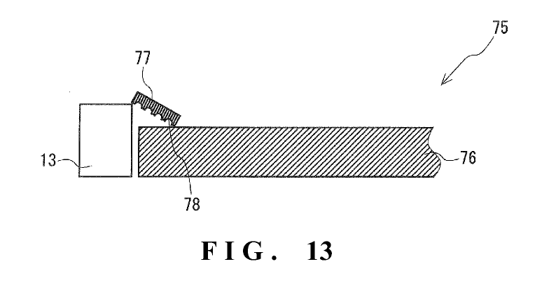

A backlight unit 75 of FIG. 13 includes a light guide film 76, at least one thin light source 13 that allows rays of light to enter an end face of the light guide film 76, and a first reflection tape 77 that is disposed in parallel with an end side of the light guide film 76 and disposed so as to cover a front face side of a gap between the at least one thin light source 13 and the light guide film 76. The light guide film 76 is configured with a main body solely, and the height position of a front face of the at least one thin light source 13 is higher than the height position of a front face of the light guide film 76. The first reflection tape 77 includes a plurality of light diffusion dots 78 on the back face thereof. Furthermore, a hollow region is formed between the first reflection tape 77 and the front face of the light guide film 76. According to the backlight unit 75 with such a configuration as well, rays of light emitted from the at least one thin light source 13 are allowed to enter the light guide film 76 accurately, whereby the utilization efficiency of rays of light can be enhanced and thus the improvement of luminance can be promoted. Furthermore, according to the backlight unit 75, since the hollow region is formed between the front face of the light guide film 76 and the back face of the first reflection tape 77, and the refractive index of the light guide film 76 is greater than the refractive index of the air, the rays of light are more likely to be allowed to enter the light guide film 76 from the hollow region.

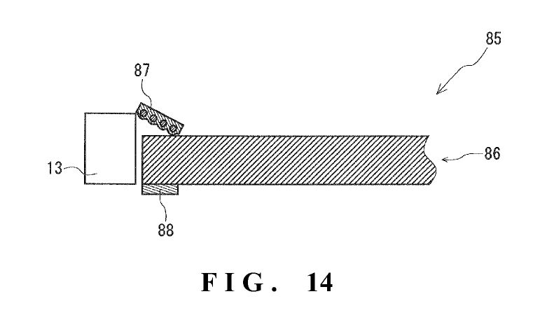

A backlight unit 85 of FIG. 14 includes a light guide film 86, at least one thin light source 13 that allows rays of light to enter an end face of the light guide film 86, and a first reflection tape 87 that is disposed in parallel with an end side of the light guide film 86 and disposed so as to cover a front face side of a gap between the at least one thin light source 13 and the light guide film 86. The backlight unit 85 further includes a second reflection tape 88 that is disposed so as to cover a back face of the light guide film 86 of an end edge on the side of the at least one thin light source 13. The second reflection tape 88 is disposed in a region on the back face side corresponding to the region of the light guide film 86 at which the first reflection tape 87 is disposed. According to the backlight unit 85, since the light guide film 86 includes the second reflection tape 88 in the region of the back face side corresponding to the region in which the first reflection tape 87 is disposed, rays of light that are reflected by the first reflection tape 87 and allowed to enter the light guide film 86 are inhibited from being allowed to exit from the back face side of the light guide film 86, and thus the utilization efficiency of rays of light can be enhanced.

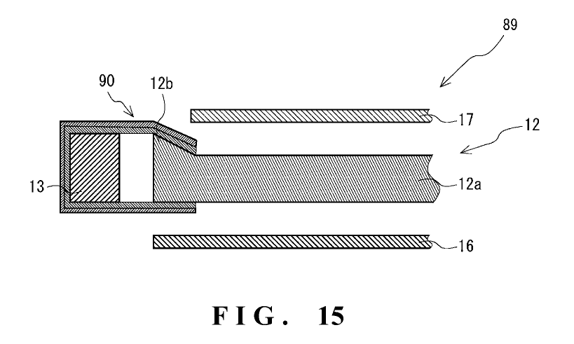

A backlight unit 89 of FIG. 15 is similar to the backlight unit 11 of FIG. 2 except for the configurations of the first reflection tape and the second reflection tape. According to the backlight unit 89, one end side of a reflection tape 90 is disposed on the surface of the prism portion 12b of the light guide film 12, and the other end side is disposed on a back face of a main body 12a of the light guide film 12. According to the backlight unit 89, a single reflection tape 90 extends from a surface of the prism portion 12b to the back face of the light guide film 12 over a circumferential surface of the at least one thin light source 13. In other words, according to the backlight unit 89, the single reflection tape 90 serves as both the configurations of the first reflection tape and the second reflection tape. According to the backlight unit 89 with such a configuration as well, rays of light emitted from the at least one thin light source 13 are allowed to enter the light guide film 12 accurately, whereby the utilization efficiency of rays of light can be enhanced and thus the improvement of luminance can be promoted. Furthermore, according to the backlight unit 89, since the configurations of the first reflection tape and the second reflection tape can be attained with the single reflection tape 90, the reflection tape can be readily disposed, leading to superior operability.

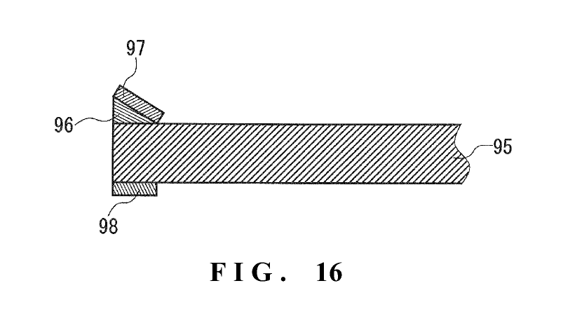

In addition, a configuration illustrated in FIG. 16, for example, can be adopted as the configuration of the backlight unit including the light guide film, the first reflection tape and the second reflection tape. A light guide film 95 of FIG. 16 is configured with a main body solely. Furthermore, the light guide film 95 includes a triangular prism portion 96 which is formed with a material different from that of a main body and formed such that the thickness of the light guide film 95 at the end edge, at which the at least one thin light source is disposed, increases gradually along the front face toward the end side of the light guide film 95. Furthermore, a first reflection tape 97 is disposed on the surface of the prism portion 96, and a second reflection tape 98 is disposed in a region on a back face side of the light guide film 95 corresponding to the region in which the first reflection tape 97 is disposed. According to the backlight unit, even when the light guide film 95, the first reflection tape 97 and the second reflection tape 98 have such a configuration, rays of light emitted from the at least one thin light source are allowed to enter the light guide film 95 accurately, whereby the utilization efficiency of rays of light can be enhanced and thus the improvement of luminance can be promoted.

The light guide film described above may not necessarily include a diffusion pattern on the back face thereof. The mobile terminal is exemplified by not only the aforementioned laptop computer but also various types of mobile terminals including e.g., mobile phone terminals such as a smartphone as well as mobile information terminals such as a tablet type terminal.

### INDUSTRIAL APPLICABILITY

As described hereinabove, according to the edge-lit backlight unit and the reflection tape member of the embodiments of the present invention, since rays of light emitted from a light source are allowed to enter a light guide film accurately, whereby the utilization efficiency of rays of light can be enhanced and thus the improvement of luminance can be promoted, thereby permitting suitable use for a liquid crystal display device with an enhancement of the luminance promoted.

### EXPLANATION OF THE REFERENCE SYMBOLS

1 mobile terminal, ultraslim computer
2 operation unit
3 liquid crystal display unit
4 liquid crystal panel
5 casing for liquid crystal display unit
6 top plate
7 surface support member
8 hinge part
9 casing for operation unit
11 backlight unit
12 light guide film
12a main body
12b prism portion
12c inclined face
13 thin light source
14 first reflection tape
15 second reflection tape
16 reflection sheet
17 optical sheet
18 reflection layer
19 adhesive layer
20 reflection layer
21 adhesive layer
31 extrusion molding apparatus
32 T die
33 pressure roll
33a pressure roll
33b pressure roll
41 backlight unit
42 first reflection tape
43 reflection layer
44 adhesive layer
51 backlight unit
52 light guide film
53 first reflection tape
54 second reflection tape
55 backlight unit
56 light guide film
57 first reflection tape
58 light guide film
58a main body
58b prism portion
61 backlight unit
62 light guide film
63 first reflection tape
64 second reflection tape
65 backlight unit
66 light guide film
67 first reflection tape
71 backlight unit
72 light guide film
73 first reflection tape
74 second reflection tape
75 backlight unit
76 light guide film
77 first reflection tape
78 light diffusion dot
81 backlight unit
82 light guide film
83 first reflection tape
84 second reflection tape
85 backlight unit
86 light guide film
87 first reflection tape
88 second reflection tape
89 backlight unit
90 reflection tape
91 backlight unit
92 light guide film
93 first reflection tape
94 second reflection tape
95 light guide film
96 prism portion
97 first reflection tape
98 second reflection tape
110 edge-lit backlight unit
111 light guide plate
112 optical sheet
115 reflection sheet
116 top plate
117 light source
X gap

1. An edge-lit backlight unit comprising:
a light guide film having an average thickness of no less than 100 μm and no greater than 600 μm;
at least one thin light source disposed so as to face at least one end face of the light guide film, wherein rays of light emitted from the thin light source exit from a front face of the light guide film; and
a first reflection tape disposed so as to cover a front face side of an end edge on a side of the at least one thin light source of the light guide film.

2. The edge-lit backlight unit according to claim 1,
wherein the first reflection tape is disposed so as to cover a front face side of a gap between the at least one thin light source and the light guide film.

3. The edge-lit backlight unit according to claim 1, further comprising a second reflection tape disposed so as to cover a back face side of the gap between the at least one thin light source and the light guide film.

4. The edge-lit backlight unit according to claim 1,
wherein the light guide film comprises a triangular prism portion which is formed so that a thickness of the light guide film at the end edge, at which the at least one thin light source is disposed, increases gradually along a front face toward an end side of the light guide film, and
wherein the first reflection tape is disposed so as to cover a front face of the prism portion.

5. The edge-lit backlight unit according to claim 1,
wherein the first reflection tape comprises a reflection layer comprising a matrix comprising a resin as a principal component, and a white pigment comprised in the matrix.

6. The edge-lit backlight unit according to claim 5, wherein
the first reflection tape further comprises an adhesive layer laminated on the reflection layer, and
the first reflection tape is bonded to the at least one thin light source and the light guide film by means of the adhesive layer.

7. The edge-lit backlight unit according to claim 6,
wherein the first reflection tape is bonded to the at least one thin light source and the light guide film in a temporarily adhered state.

8. A reflection tape member used as the first reflection tape of the edge-lit backlight unit according to claim 1.
